(19) United States
(12) Patent Application Publication
(10) Pub. No.: US 2015/0354657 A1
(43) Pub. Date: Dec. 10, 2015

(54) SHOCK ABSORBER

(71) Applicant: KAYABA INDUSTRY CO., LTD., Tokyo (JP)

(72) Inventor: Satoru TAKEO, Gifu (JP)

(73) Assignee: KAYABA INDUSTRY CO., LTD., Tokyo (JP)

(21) Appl. No.: 14/760,148

(22) PCT Filed: Jan. 28, 2014
(86) PCT No.: PCT/JP2014/051842

§ 371 Date: Jul. 9, 2015

(30) Foreign Application Priority Data
Feb. 4, 2013 (JP) 2013-019693

(51) Int. Cl. F16F 9/38; F16F 9/18

(52) U.S. Cl. CPC F16F 9/38; F16F 9/18

(57) ABSTRACT

A shock absorber includes a shock absorber body having an outer shell and a piston rod, the shock absorber body being configured to generate a damping force for suppressing relative movement in an axial direction of the piston rod with respect to the outer shell; a dust cover connected to the piston rod, the dust cover allowing the outer shell to enter an inner part; an extension cover formed in a belt-like shape to be wound around an outer circumference of the dust cover, the extension cover extending from the dust cover to an outer shell side, the outer shell being inserted into an inner side of the extension cover; and a fixing member configured to fix the extension cover in a state that the extension cover is wound around the outer circumference of the dust cover.

### TECHNICAL FIELD

This invention relates to a shock absorber.

### BACKGROUND ART

A shock absorber has an outer shell and a piston rod retractably inserted into the outer shell. The shock absorber generates a damping force for suppressing a relative movement of the piston rod with respect to the outer shell when the piston rod moves relatively to the outer shell in an axial direction. For example, the shock absorber is interposed between a vehicle body and an axle of a vehicle or between a cabin and a vehicle body. Vibration of a damping target, such as the vehicle body, the cabin or the like, can be suppressed by the damping force generated by the shock absorber.

Since a shock absorber is exposed to the outside in use, dust, dirt, and mud (hereinafter, referred to as “mud and the like”) are easily adhered to the piston rod. Mud and the like adhered to the outer circumference of the piston rod are scraped off by a dust seal that seals the outer circumference of the piston rod when the piston rod is inserted into the outer shell. However, when the mud and the like are dried and are strongly adhered to the piston rod so that they are not easily scraped off by the dust seal, an oil seal provided in an inner side of the dust seal may be deteriorated. In this regard, in JP 2000-81071 A and JP 2010-175043 A, there is disclosed a technique of installing a dust cover for covering the outer circumference of the piston rod and protecting the piston rod from mud and the like.

### SUMMARY OF INVENTION

As described above, in the case of the shock absorber having the dust cover, it is possible to more effectively prevent adherence of mud and the like to the piston rod as the length of the dust cover increases. However, as the length of the dust cover increases, the dust cover may cover the outer shell and generate an uncoated portion in the upper end of the outer shell when spray coating is performed for an outer surface of the outer shell. As a result, an anti-rusting effect is degraded in the upper end of the outer shell.

In this regard, in the shock absorber disclosed in JP 2000-81071 A, the entire length of the dust cover is set to slightly cover the upper end of the outer shell when the shock absorber fully expands in order to prevent generation of an uncoated portion. However, in this case, mud and the like may easily intrude into an inner part of the dust cover from a gap between the outer shell and the dust cover, and the protection effect for protecting the outer circumference of the piston rod is degraded.

In addition, in the shock absorber discussed in JP 2010-175043 A, while the entire length of the dust cover is set to be long enough to suppress intrusion of mud and the like, the spray coating is performed before installation of the dust cover. However, in this case, it is necessary to perform the spray coating for the outer circumference of the outer shell while the piston rod is forcibly inserted into the outer shell, and the shock absorber contracts fully, in order to prevent a sliding surface of the outer circumference of the piston rod from being coated. As a result, it is necessary to perform the spray coating by setting the shock absorber on a mechanical tool, so that the coating process becomes cumbersome and consumes manpower.

In this regard, it is considered that the dust cover may be extended to an outer shell side by providing a cylindrical extension cover in an end of the outer shell side of the dust cover after the spray coating for the outer surface of the outer shell. As a result, since the length of the dust cover is set to slightly cover the upper end of the outer shell, it is possible to prevent degradation of coatability and generation of an uncoated portion. In addition, since the extension cover is installed after the spray coating, it is possible to protect the outer circumference of the piston rod.

However, installation portions for interposing the shock absorber between a vehicle body and a wheel are fixed in the cylinder end and the piston rod end positioned in both ends of the shock absorber. For this reason, in order to install the extension cover formed in a cylindrical shape to the dust cover in advance, it is necessary to form an inner diameter of the extension cover to be large enough to pass at least one of the installation portions.

A size of the installation portion changes depending on a vehicle where the shock absorber is mounted and an outer diameter of the outer shell also changes depending on a type of the shock absorber. Therefore, when a single type of the extension cover is used in a plurality of types of shock absorbers, it is difficult to use it in a shock absorber having a large installation portion. If the inner diameter of the extension cover is widened to match the large installation portion, a gap between the extension cover and the outer shell is significantly widened, so that a protection effect for protecting the outer circumference of the piston rod may be degraded. That is, since the extension cover has poor compatibility, it is necessary to prepare various types of extension covers having different inner diameters depending on the size of the installation portion or the outer diameter of the outer shell. In addition, even when various types of extension covers having different inner diameters are prepared, the type of the shock absorber where the extension cover can be applied is limited.

In view of the aforementioned problems, it is therefore an object of this invention to improve compatibility of the extension cover and provide a shock absorber capable of sufficiently protecting the outer circumference of the piston rod and preventing degradation of coatability.

According to one aspect of the present invention, a shock absorber includes a shock absorber body having a cylindrical outer shell and a piston rod retractably inserted into the outer shell, the shock absorber body being configured to generate a damping force for suppressing relative movement in an axial direction of the piston rod with respect to the outer shell; a cylindrical dust cover connected to the piston rod, the dust cover allowing the outer shell to enter an inner part thereof; an extension cover formed in a belt-like shape to be wound around an outer circumference of the dust cover, the extension cover extending from the dust cover to an outer shell side, the outer shell being inserted into an inner side of the extension cover; and a fixing member configured to fix the extension cover in a state that the extension cover is wound around the outer circumference of the dust cover.

### BRIEF DESCRIPTION OF DRAWINGS

FIG. 1 is a partial cross-sectional view illustrating a shock absorber according to an embodiment of this invention viewed from a front;

FIG. 2A is a diagram illustrating a dust cover as viewed from the inside by uninstalling an extension cover from the dust cover;

FIG. 2B is a diagram illustrating the dust cover as viewed from the outside by uninstalling the extension cover from the dust cover;

FIG. 3 is an enlarged cross-sectional view taken along the line III-III of FIG. 2B;

FIG. 4A is a partially enlarged diagram illustrating a part of the dust cover and a part of FIG. 3;

FIG. 4B is a diagram illustrating a state that a groove of the dust cover and a protrusion of the extension cover are combined with each other;

FIG. 5A is an enlarged cross-sectional view illustrating a belt before the belt passes through a through-hole of a head; and

FIG. 5B is an enlarged cross-sectional view illustrating the belt after the belt passes through the through-hole of the head.

### DESCRIPTION OF EMBODIMENTS

A description will now be made for embodiments of this invention with reference to the accompanying drawings.

Like reference numerals or signs denote like elements throughout several drawings.

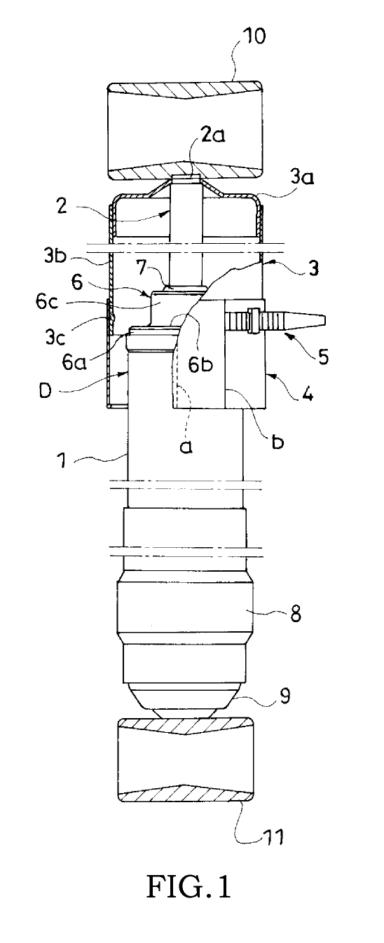

Referring to FIG. 1, a shock absorber includes a shock absorber body D that has a cylindrical outer shell 1 and a piston rod 2 retractably inserted into the outer shell 1 to generate a damping force for suppressing relative movement in an axial direction of the piston rod 2 with respect to the outer shell 1; a cylindrical dust cover 3 connected to the piston rod 2, the dust cover 3 allowing the outer shell 1 to enter thereof; an extension cover 4 formed in a belt-like shape to be wound around the outer circumference of the dust cover 3, the extension cover 4 extending from the dust cover 3 to an outer shell side, the outer shell 1 being inserted into an inner part of extension cover 4; and a fixing member 5 configured to fix the extension cover 4 in a state that the extension cover 4 wound around the outer circumference of the dust cover 3.

For example, the shock absorber body D includes an inner tube (not shown) housed in the outer shell 1, a piston (not shown) slidably inserted into the inner tube, a piston rod 2 having one end connected to the piston and movably inserted into the inner tube, an expansion-side chamber and a compression-side chamber (not shown) partitioned by the piston inside the inner tube, and a passage (not shown) that causes the expansion-side chamber and the compression-side chamber to communicate with each other. A liquid such as a hydraulic fluid is filled in the expansion-side chamber and the compression-side chamber. The liquid may include, for example, water, an aqueous solution, or the like instead of the hydraulic fluid.

Referring to FIG. 1, installation portions 10 and 11 for installing the shock absorber to a vehicle are fixed to upper and lower ends of the shock absorber body D, one of the installation portions 10 is connected to the vehicle body side of the vehicle, and the other installation portion 11 is connected to the wheel side of the vehicle. As an external force is input to the wheel, the piston rod 2 relatively moves in an axial direction with respect to the outer shell 1. That is, the shock absorber body D expands/contracts by virtue of the external force. As the shock absorber body D expands/contracts, the piston moves in an axial direction along with the piston rod 2 to compress the expansion-side chamber or the compression-side chamber inside the inner tube to generate a pressure difference between the pressures of the expansion-side chamber and the compression-side chamber. As this pressure difference is applied to the piston, the shock absorber body D generates a damping force for suppressing relative movement in an axial direction between the outer shell 1 and the piston rod 2.

Since the shock absorber body D is a single-rod type in which the piston rod 2 is inserted only into the expansion-side chamber, a reservoir that houses gas and liquid is formed in an annular gap between the outer shell 1 and the inner tube. As a result, a volume of the piston rod 2 that enters an inner part of the outer shell 1 as the shock absorber body D expands/contracts is compensated. That is, the shock absorber body D is set to a single-rod twin-tube type.

It is noted that the expansion-side chamber and the compression-side chamber may be partitioned inside the outer shell 1 by the piston directly slide along the inner circumference of the outer shell 1. In this case, a free piston may be slidably inserted into the outer shell 1 to partition an air chamber for compensating for a volume of the piston rod 2 inside the outer shell 1 or partition an air chamber inside the outer shell 1 using an elastic partitioning wall such as a bladder. In this case, the shock absorber body D may be set to a mono-tube type in which no inner tube is provided. In addition, the shock absorber body D may be set to a double rod type instead of the single rod type.

The outer shell 1 has a cylindrical shape. The lower end of the outer shell 1 in FIG. 1 is sealed with a cap 9, and the upper end of the outer shell 1 in FIG. 1 is installed with a cylindrical seal casing 6. The seal casing 6 has a cylindrical large-diameter portion 6a mounted to the inner circumference of the upper end of the outer shell 1 in the downward side in FIG. 1, a toroidal flange portion 6b protruding inward from the upper end of the large-diameter portion 6a in FIG. 1, and a cylindrical small-diameter portion 6c rising upward in an axial direction from the inner circumference of the flange portion 6b. A seal member 7 is housed in the small-diameter portion 6c.

The seal member 7 has a seal portion that brings into sliding contact with the outer circumference of the piston rod 2 to seal the outer circumference of the piston rod 2 and prevent a liquid from leaking from the outer shell 1, and a dust seal portion that scrapes off dust attached on the outer circumference of the piston rod 2.

In the upper end 2a of the piston rod 2 in FIG. 1, the dust cover 3 is installed under the installation portion 10. The dust cover 3 has an annular connecting portion 3a having an inner circumference mounted to the outer circumference of the piston rod 2, and a cover body 3b extending from the outer circumference of the connecting portion 3a downward in FIG. 1. In the outer circumference of the cover body 3b in the lower part of FIG. 1, an annular groove 3c extending in the circumferential direction is formed across the entire circumference. The groove 3c is formed by reducing an inner diameter of a part of the cover body 3b corresponding to the groove 3c compared to other parts. The inner diameter of the reduced portion is larger than the outer diameter of the outer shell 1. As a result, it is possible to allow the outer shell 1 to enter the inside of the cover body 3b, and the dust cover 3 does not hinder expansion/compression of the shock absorber body D.

It is noted that, according to this embodiment, in order to obtain a sufficient depth of the groove 3c with reducing a thickness of the cover body 3b, the groove 3c is formed by reducing the inner diameter of the part of the cover body 3b corresponding to the groove 3c. Alternatively, the inner diameter of the part of the cover body 3b corresponding to the groove 3c may not be reduced as long as the sufficient depth of the groove 3c is obtained.

In the lower part of the cover body 3b in FIG. 1, the extension cover 4 is installed by using the fixing member 5. The extension cover 4 is formed of an elastic body. It is noted that, in the following description, in a state that the extension cover 4 is wound around the dust cover 3, the dust cover side of the extension cover 4 will be referred to as an inner side, the side opposite to the dust cover will be referred to as an outer side, the outer shell side will be referred to as a lower side, the side opposite to the outer shell will be referred to as an upper side, a winding starting-side end portion will be referred to as a starting end “a”, and a winding terminating-side end portion will be referred to as a terminating end “b”.

The extension cover 4 is fixed to the dust cover 3 by tightening its upper portion using the fixing member 5, and its lower portion protrudes downward from the dust cover 3. A material of the extension cover 4 may be appropriately selected as long as the extension cover 4 is formed in a belt-like shape so as to be wound or unwound in a cylindrical shape, and the cylindrical shape can be maintained when it is wound in the cylindrical shape. Since the extension cover 4 is an exterior component, a material of the extension cover 4 is preferably selected from a group of materials having elasticity and excellent weather resistance, such as a group of nitrile butadiene rubber/polyvinyl chloride (NBR/PVC) blends.

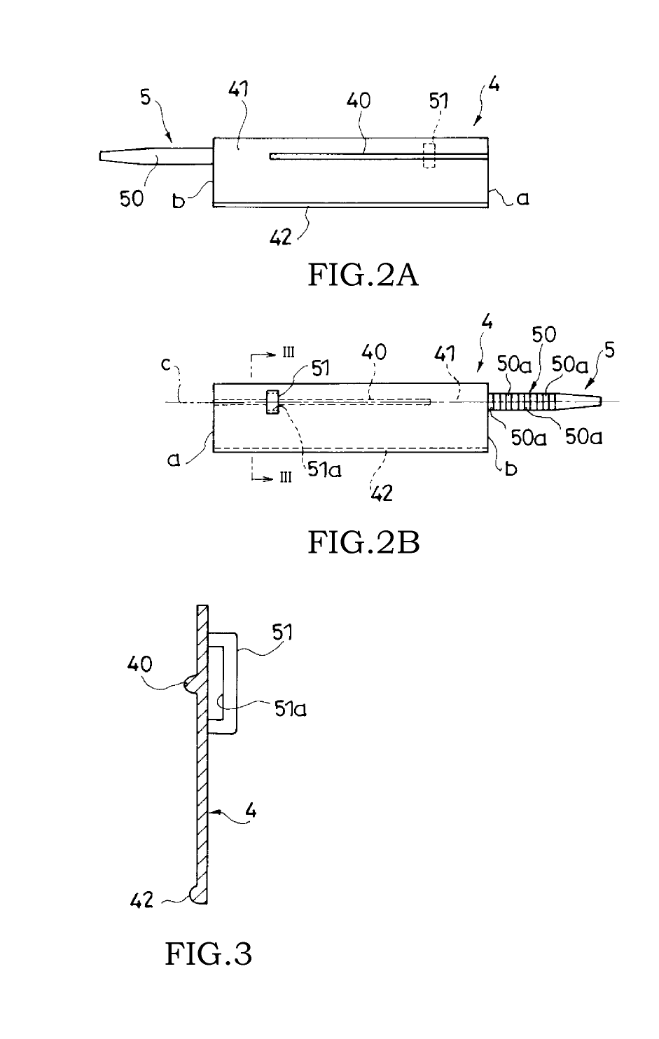

Referring to FIGS. 2A and 2B, a single linear protrusion 40 erected along a longitudinal direction is formed in an upper portion of the inner side of the extension cover 4. The protrusion 40 extends from the starting end “a” of the extension cover 4 to the terminating end “b”, but does not reach the terminating end “b”. A planar portion 41 having no protrusion 40 is formed between the left end of the protrusion 40 and the terminating end “b” in FIG. 2A. In addition, a linear auxiliary protrusion 42 erected along a longitudinal direction is formed in the lower end of the inner side of the extension cover 4. The auxiliary protrusion 42 protrudes to the inner side and has a rounded leading end as illustrated in FIG. 3. The auxiliary protrusion 42 is formed to extend from the starting end “a” of the extension cover 4 to the terminating end “b” as illustrated in FIGS. 2A and 2B.

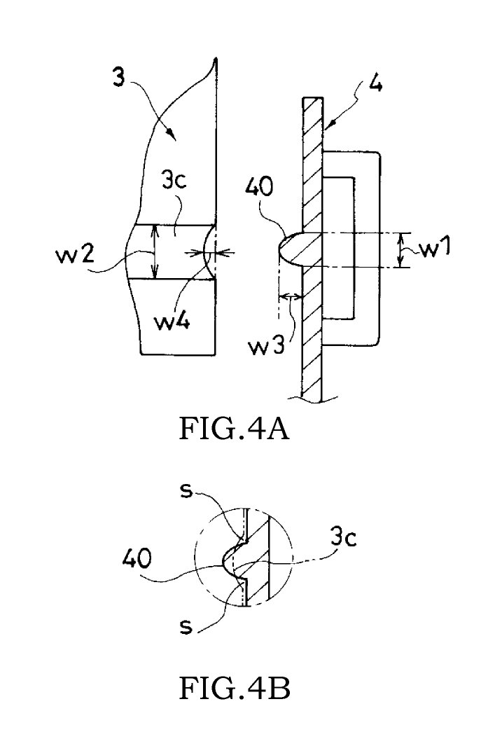

Referring to FIG. 4A, a width w1 in a transverse direction of the protrusion 40 is narrower than a width w2 in a transverse direction of the groove 3c of the dust cover 3. A protruding length w3 of the protrusion 40 is longer than a depth w4 of the groove 3c. For this reason, as illustrated in FIG. 4B, as the protrusion 40 and the groove 3c are overlapped with each other, gaps S are formed in the upper and lower sides of the protrusion 40. When the extension cover 4 is tightly fixed to the dust cover 3 using the fixing member 5, the protrusion 40 is pressed inside the groove 3c and is elastically deformed toward the gaps S to fill the groove 3c.

The protruding length of the auxiliary protrusion 42 illustrated in FIGS. 2A, 2B, and 3 is set not to interfere with a protector 8 mounted to the outer circumference in the lower end of the outer shell 1 when the extension cover 4 is wound around the dust cover 3, and the shock absorber body D fully contracts.

The fixing member 5 configured to fix the extension cover 4 in a state that the extension cover 4 is wound around the dust cover 3 is integrally formed with the extension cover 4. As illustrated in FIG. 2B, the fixing member 5 includes a band 50 extending from the terminating end “b” of the extension cover 4; and a head 51 fixed to the exterior side of the extension cover 4, the band 50 being to be inserted into a through-hole 51a (FIG. 3) formed in the head 51. As illustrated in FIG. 2B, the band 50 and the through-hole 51a are arranged along a center line “c” passing through a center of the transverse direction of the protrusion 40.

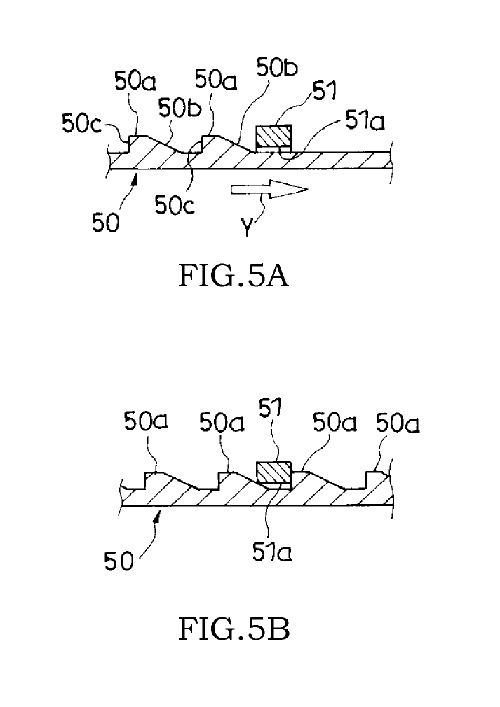

Furthermore, the band 50 includes a plurality of teeth 50a arranged side by side in the outer side opposite to the dust cover when the extension cover 4 is installed in the dust cover 3. As illustrated in FIG. 5A, each tooth 50a includes an insertion-side face 50b having a smooth slope in an insertion direction (arrow direction Y in FIG. 5A) of the band 50 as the band 50 passes through the through-hole 51a, and a retreating-side face 50c having a steep slope in the side opposite to the insertion-side face 50b. As a result, as the band 50 passes through the through-hole 51a, the tooth 50a serves as a stopper as illustrated in FIG. 5B, so that it is possible to prevent the band 50 from being loosened from the head 51, that is, from retreat opposite to the arrow direction Y. It is noted that, although FIG. 1 illustrates a state that an extra tail of the band 50 from the head 51 after the band 50 is fastened is not cut off, the extra tail from the head 51 may also be cut off.

Next, a description will be made for a sequence of installing the extension cover 4 in the dust cover 3.

First, spray coating is performed for the outer surfaces of the outer shell 1 and the dust cover 3 while the dust cover 3 is installed in the shock absorber body D. The length of the dust cover 3 is set such that the lower end of FIG. 1 slightly covers the upper end of the outer shell 1 when the shock absorber body D is fully expanded. Therefore, even when the coat is sprayed, the coat is not attached to the outer circumference of the piston rod 2, but is sufficiently attached to the outer surface of the outer shell 1.

After the spray coating is completed, the extension cover 4 is wound around the outer circumference of the dust cover 3 and is fixed using the fixing member 5. In this case, since the dust cover 3 has the groove 3c, and the extension cover 4 has the protrusion 40, it is possible to wind the extension cover 4 from the starting end “a” of the extension cover 4 while the protrusion 40 is inserted into the groove 3c. For this reason, it is possible to position the extension cover 4 in a uniform installation position and suppress a displacement between the extension cover 4 and the dust cover 3.

As the band 50 extending from the terminating end “b” of the extension cover 4 is pulled through the through-hole 51a of the head 51, the extension cover 4 is tightly fixed around the outer circumference of the dust cover 3 using the band 50. Since the band 50 and the through-hole 51a are arranged along the center line “c” of the protrusion 40, the protrusion 40 can be pressed into the groove 3c by virtue of a tightening force generated when fastening the band 50 so that it is possible to prevent the protrusion 40 from floating from the groove 3c. In addition, since the planar portion 41 is provided in the terminating end side of the extension cover 4, it is possible to cause the terminating end side and the starting end side of the extension cover 4 to abut on each other when the planar portion 41 is overlapped with the outer side of the starting end side of the extension cover 4. In addition, since the band 50 is provided with the teeth 50a, it is possible to prevent the band 50 from being loosened from the head 51 and maintain the tight condition.

Next, a description will be made for the effects of the shock absorber according to this embodiment.

The shock absorber includes a shock absorber body D that has a cylindrical outer shell 1 and a piston rod 2 retractably inserted into the outer shell 1 to generate a damping force for suppressing relative movement in an axial direction of the piston rod 2 with respect to the outer shell 1; a cylindrical dust cover 3 connected to the piston rod 2, the dust cover 3 allowing the outer shell 1 to enter thereof; an extension cover 4 formed in a belt-like shape to be wound around the outer circumference of the dust cover 3, the extension cover 4 extending from the dust cover 3 to an outer shell side, the outer shell 1 being inserted into an inner part of extension cover 4; and a fixing member 5 configured to fix the extension cover 4 in a state that the extension cover 4 wound around the outer circumference of the dust cover 3.

In a state that the extension cover 4 is installed in the dust cover 3, the lower end of the extension cover 4 in FIG. 1 is arranged in the outer shell side (in the lower side in FIG. 1) relative to the lower end of the dust cover 3 in FIG. 1. Therefore, it is possible to cover the outer shell 1 across an area wider than that covered only by the dust cover 3. As a result, an intrusion path of mud and the like reaching the piston rod 2 from the lower end of the extension cover 4 becomes longer than those of other shock absorbers of the prior art. Therefore, mud and the like do not easily intrude into an inner part of the dust cover 3 from a gap between the outer shell 1 and the dust cover 3 and a gap between the outer shell 1 and the extension cover 4, and it is possible to prevent mud and the like from being attached to the piston rod 2.

Since the spray coating is performed before installation of the extension cover 4, it is possible to prevent an uncoated portion from being generated on the outer surface of the outer shell 1 and prevent corrosion in the outer shell 1. Furthermore, since the dust cover 3 and the outer shell 1 can be coated before installation of the extension cover 4, there is no need to maintain the shock absorber body D in a fully contracting state before installation of the dust cover 3 or mask the outer circumference of the piston rod 2. Therefore, it is possible to simplify the coating process.

In this manner, in the shock absorber, it is possible to sufficiently protect the outer circumference of the piston rod 2 and prevent degradation of coatability.

The extension cover 4 is formed in a belt-like shape so as to be windingly fixed to the outer circumference of the dust cover 3. For this reason, it is possible to install the extension cover 4 to the dust cover 3 regardless of the sizes of the installation portions 10 and 11. In addition, regardless of the sizes of the installation portions 10 and 11, the inner diameter of the extension cover 4 substantially conforms to the outer diameter of the dust cover 3 when the extension cover 4 is wound around the dust cover 3 in a cylindrical shape. Therefore, it is possible to suppress the gap between the outer shell 1 and the extension cover 4 from increasing excessively and improve a protection effect for protecting the outer circumference of the piston rod 2.

Therefore, compared to a case where the extension cover formed in a cylindrical shape is installed in the dust cover 3 in advance, a single type of the extension cover can be used in more types of shock absorbers. As a result, it is possible to remarkably improve compatibility of the extension cover 4.

The groove 3c formed on the dust cover 3 along the outer circumference thereof, and the linear protrusion 40 inserted into the groove 3c is formed on the inner side (dust cover side) of the extension cover 4. Therefore, by inserting the protrusion 40 into the groove 3c when the extension cover 4 is wound around the dust cover 3, it is possible to position the extension cover 4 in a uniform installation position and uniformize a length of a part of the extension cover 4 projecting from the dust cover 3 to the outer shell side. Furthermore, it is possible to suppress a displacement between the extension cover 4 and the dust cover 3.

The extension cover 4 is formed of an elastic body. Therefore, even when a stone or the like hits to the lower end of the extension cover 4 during traveling of a vehicle, and an upward force is applied, the extension cover 4 is flexed to absorb this force, so that it is possible to prevent the extension cover 4 from being displaced from a predetermined position or from being uninstalled from the dust cover 3.

The width w1 in the transverse direction of the protrusion 40 is smaller than the width w2 in the transverse direction of the groove 3c, and the protruding length w3 of the protrusion 40 is longer than the depth w4 of the groove 3c. Therefore, the protrusion 40 can be pressed and elastically deformed inside the groove 3c to fill the groove 3c, so that it is possible to more reliably suppress a displacement between the extension cover 4 and the dust cover 3.

The auxiliary protrusion 42 is formed on the extension cover 4 along the end portion of the lower side (outer shell side) so that a rounded leading end thereof protrudes to the dust cover side. Therefore, it is possible to narrow the gap between the outer shell 1 and the lower end of the extension cover 4, which may otherwise serve as an intrusion hole of mud and the like, as much as the auxiliary protrusion 42 protrudes. Therefore, it is possible to more reliably suppress intrusion of mud and the like and more improve the protection effect for protecting the outer circumference of the piston rod 2. Furthermore, since the leading end of the auxiliary protrusion 42 is rounded, it is possible to suppress a flaw that may be generated on the surface of the outer circumference of the outer shell 1 by the auxiliary protrusion 42 even when the auxiliary protrusion 42 makes contact with the outer shell 1.

The fixing member 5 includes the band 50 extending from the terminating end “b” which is a winding terminating side end portion of the extension cover 4; and the head 51 fixed to the outer side (opposite to the dust cover) of the extension cover 4, the band 50 being to be inserted into the through-hole 51a formed in the head 51. Therefore, when the extension cover 4 is tightened around the outer circumference of the dust cover 3 using the band 50, the protrusion 40 of the extension cover 4 is pressed to the groove 3c of the dust cover 3 by virtue of the tightening force. Accordingly, it is possible to suppress the protrusion 40 from floating from the groove 3c.

The protrusion 40 does not reach the terminating end “b”, and the planar portion 41 is provided in the terminating end side of the extension cover 4. As a result, it is possible to overlap the terminating end side of the extension cover 4 with the outer side of the starting end side of the extension cover 4 while the planar portion 41 abuts on the starting end side of the extension cover 4.

Embodiments of this invention were described above, but the above embodiments are merely examples of applications of this invention, and the technical scope of this invention is not limited to the specific constitutions of the above embodiments.

For example, although, in the embodiment described above, the groove 3c is formed on the outer circumference of the dust cover 3, and the protrusion 40 is formed on the inner side (dust cover side) of the extension cover 4, an annular protrusion may be formed on the outer circumference of the dust cover 3 along the circumferential direction, and a linear groove may be formed on the inner side of the extension cover 4. In this case, it is possible to position the extension cover 4 and the dust cover 3 using the protrusion and the groove and prevent a deviation therebetween.

Alternatively, grooves may be formed on both facing surfaces of the dust cover 3 and the extension cover 4, and an annular member fitting to both the grooves may be provided. In this case, using the grooves and the annular member, it is possible to position the extension cover 4 and the dust cover 3 and prevent a deviation therebetween. In addition, the groove or the protrusion is not necessarily provided. In this case, any other configuration may also be employed so that it can position the extension cover 4 and the dust cover 3 and prevent a deviation therebetween.

Although, in the embodiment described above, the extension cover 4 is formed of an elastic body having a belt-like shape, the extension cover 4 is not necessarily to be formed of the elastic body. Any other material may also be employed appropriately for forming the extension cover 4 as long as the extension cover 4 can be formed in a belt-like shape, and can be wound or unwound in a cylindrical shape, so that a cylindrical shape can be maintained when it is wound in the cylindrical shape. For example, the extension cover 4 may have a shutter-like configuration formed by joining hard plates together just like a bamboo screen.

Although, in the embodiment described above, the width w1 in the transverse direction of the protrusion 40 formed on the inner side (dust cover side) of the extension cover 4 is smaller than the width w2 in the transverse direction of the groove 3c formed on the outer circumference of the dust cover 3, and the protruding length w3 of the protrusion 40 is longer than the depth w4 of the groove 3c, a dimensional relationship is not limited thereto, and may change appropriately.

Although, in the embodiment described above, the fixing member 5 includes the band 50 extending from the terminating end “b” of the extension cover 4 and the head 51 fixed to the outer side (opposite to the dust cover) of the extension cover 4 and provided with the through-hole 51a into which the band 50 is inserted, so that the fixing member 5 is integrally formed with the extension cover 4 in a single body, the extension cover 4 and the fixing member 5 may be provided as separate bodies. For example, the fixing member 5 may include a binding tie or a belt provided with a buckle known in the art, so that the fixing member is wound around the extension cover 4 and is tightened. Even in this case, in order to prevent floating of the protrusion 40, the fixing member is preferably wound along the center line “c” of the protrusion 40.

Although, in the embodiment described above, the band 50 and the through-hole 51a of the fixing member 5 are arranged along the center line “c” of the protrusion 40, they may also be arranged in any other position. Alternatively, in a case where a protrusion is formed on the outer circumference of the dust cover 3 along the circumferential direction of the dust cover 3, and a linear groove into which the protrusion is inserted is formed on the inner side of the extension cover 4, the band 50 and the through-hole 51a are preferably arranged along the center line passing through the center in the transverse direction of the groove. Even in this case, when the extension cover 4 is tightened around the outer circumference of the dust cover 3 using the band 50, the groove of the extension cover 4 is pressed to the protrusion of the dust cover 3 by virtue of the tightening force. Therefore, it is possible to suppress the groove from floating from the protrusion.

Alternatively, although, in the embodiment described above, a single auxiliary protrusion 42 protruding to the dust cover side is formed along the end portion of the lower side (outer shell side) of the extension cover 4, a plurality of the auxiliary protrusions 42 may be provided, or the auxiliary protrusion 42 may not be provided.

Alternatively, although, in the embodiment described above, the planar portion 41 where no protrusion 40 is erected is provided in the terminating end side of the extension cover 4, the protrusion 40 may extend from the starting end “a” to the terminating end “b” without providing the planar portion 41.

This application claims priority based on Japanese Patent Application No. 2013-019693 filed with the Japan Patent Office on Feb. 4, 2013, the entire contents of which are incorporated into this specification.

1. A shock absorber comprising:
a shock absorber body having a cylindrical outer shell and a piston rod retractably inserted into the outer shell, the shock absorber body being configured to generate a damping force for suppressing relative movement in an axial direction of the piston rod with respect to the outer shell;
a cylindrical dust cover connected to the piston rod, the dust cover allowing the outer shell to enter an inner part thereof;
an extension cover formed in a belt-like shape to be wound around an outer circumference of the dust cover, the extension cover extending from the dust cover to an outer shell side, the outer shell being inserted into an inner side of the extension cover; and
a fixing member configured to fix the extension cover in a state that the extension cover is wound around the outer circumference of the dust cover.

2. The shock absorber according to claim 1, wherein a groove or a protrusion is formed on the dust cover along the outer circumference thereof, and
wherein a linear protrusion to be inserted in the groove of the dust cover or a linear groove into which the protrusion of the dust cover is inserted is formed on a dust cover side of the extension cover.

3. The shock absorber according to claim 2, wherein the extension cover is formed of an elastic body.

4. The shock absorber according to claim 3, wherein a width of a transverse direction of the protrusion formed on one of the dust cover and the extension cover is smaller than a width of a transverse direction of the groove formed in the other of the dust cover and the extension cover, and
wherein a protruding length of the protrusion is longer than a depth of the groove.

5. The shock absorber according to claim 1, wherein an auxiliary protrusion is formed on the extension cover along an end portion of the outer shell side so that a rounded leading end thereof protrudes to the dust cover side.

6. The shock absorber according to claim 1, wherein the fixing member includes:
a band extending from a terminating end, the terminating end being a winding terminating side end portion of the extension cover; and
a head fixed to a side of the extension cover opposite to the dust cover, the band being to be inserted into a through-hole formed in the head.
